(19) United States
(12) Patent Application Publication
(10) Pub. No.: US 2017/0364837 A1
(43) Pub. Date: Dec. 21, 2017

(54) Methods and Apparatus for Predicting Dynamic Pricing

(71) Applicant: MASTERCARD INTERNATIONAL INCORPORATED, Purchase, NY (US)

(72) Inventors: Rakesh Tiwari, New Delhi (IN); Shashank Kumar Trivedi, Haryana (IN); Abhishek Gautam, New Delhi (IN)

(21) Appl. No.: 15/626,379

(22) Filed: Jun. 19, 2017

(30) Foreign Application Priority Data
Jun. 20, 2016 (SG) 10201605047U

(51) Int. Cl. G06Q 10/02; G06Q 30/02

(52) U.S. Cl. CPC G06Q 10/02; G06Q 30/0283

(57) ABSTRACT

A computer implemented method for predicting dynamic pricing for a product or service is disclosed. The method comprises: receiving, at a server, transaction data for a plurality transactions relating to the product or service, the transaction data comprising transaction information indicating attributes of the transaction and booking information indicating attributes of the product or service; storing the transaction data on the server as a data set; calculating, in a derived variable calculation module of the server, derived variables for the data set from the transaction information and/or the booking information; generating, in a model generation module of the server, a model for the price of the product or service as a function of the derived variables; and predicting, in a price prediction module of the server, a price for the product or service using the model.

### CROSS-REFERENCE TO RELATED APPLICATION

This application claims the benefit of and priority to Singapore Patent Application No. 10201605047U, filed Jun. 20, 2016. The entire disclosure of the above application is incorporated herein by reference.

### FIELD

The present disclosure generally relates to a method and system for processing data. In particular, it provides a method and system for predicting dynamic pricing of products and/or services, such as airline tickets.

### BACKGROUND

This section provides background information related to the present disclosure which is not necessarily prior art.

Merchants, such as Airlines, across the globe look at their businesses through flying corridors or routes. For a given flying route or corridor, airlines always try to understand how the demand is changing based on market information and optimize the prices accordingly. In general, the price of flight tickets can increase by almost 1.5 times to 2 times as the departure date approaches.

In view of the above, there is a desire on the part of merchants, such as airlines, to predict dynamically varying prices.

### SUMMARY

This section provides a general summary of the disclosure, and is not a comprehensive disclosure of its full scope or all of its features. Aspects and embodiments of the disclosure are set out in the accompanying claims.

In general terms, the present disclosure proposes a method and apparatus for predicting dynamic pricing. The pricing may relate to air tickets or hotel room prices. In the method, transaction data relating to purchases of a product or service is analyzed to generate a price model for the dynamic price of the product or service. The price may be modeled as a function of time, for example, as a function of the time to a departure date or hotel visit date. The customers' spending behavior in two defined time periods is analyzed.

According to a first aspect of the present disclosure, there is provided a computer implemented method of predicting dynamic pricing for a product or service. The method comprises receiving, at a server, transaction data for a plurality of transactions relating to the product or service, the transaction data comprising transaction information indicating attributes of the transaction and booking information indicating attributes of the product or service; storing the transaction data on the server as a data set; calculating, in a derived variable calculation module of the server, derived variables for the data set from the transaction information and/or the booking information; generating, in a model generation module of the server, a model for the price of the product or service as a function of the derived variables; and predicting, in a price prediction module of the server, a price for the product or service using the model.

In an embodiment, the attributes of the transaction comprise a time for the transaction, and one of the derived variables is a percentage of transactions within a time period. The attributes of the product or service may comprise a time associated with the product or service and the time period is a time period relative to the time associated with the product or service. The product or service may be a travel ticket and the time associated with the product or service may be a departure time.

The method may further comprise predicting a price for the product or service at a plurality of future times. The method may further comprise determining a price for the product or service at a plurality of past times using the model. Historical price data may be combined with the price for the product or service at a plurality of past times.

In an embodiment, the method further comprises sorting the transaction data in a data sorting module of the server according to an attribute of the product or service. The product or service may be a travel ticket and sorting the transaction data may comprise sorting the transaction data according to travel routes.

According to a second aspect, there is provided an apparatus for identifying customer segments from transaction data. The apparatus comprises: a computer processor and a data storage device, the data storage device having a derived variable calculation module; a model generation module; and a price prediction module comprising non-transitory instructions operative by the processor to: receiving transaction data for a plurality of transactions relating to the product or service, the transaction data comprising transaction information indicating attributes of the transaction and booking information indicating attributes of the product or service; store the transaction data as a data set; calculate derived variables for the data set from the transaction information and/or the booking information; generate a model for the price of the product or service as a function of the derived variables; and predict a price for the product or service using the model.

According to a yet further aspect, there is provided a non-transitory computer-readable medium. The computer-readable medium has stored thereon program instructions for causing at least one processor to perform operations of a method disclosed above.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. Embodiments of the disclosure will now be described for the sake of non-limiting example only, with reference to the following drawings in which:

FIG. 1 is a block diagram of a data processing system according to an embodiment of the present disclosure;

FIG. 2 is a block diagram illustrating a payment network incorporating a dynamic pricing prediction server according to an embodiment of the present disclosure;

FIG. 3 is a block diagram illustrating a technical architecture of the apparatus according to an embodiment of the present disclosure;

FIG. 4 is a flowchart illustrating a method of predicting dynamic pricing from transaction data according to an embodiment of the present disclosure;

FIG. 5 is a graph illustrating an example of an output generated by the method shown in FIG. 4; and

FIG. 6 is a flow chart showing a process of generating historical pricing data according to an embodiment of the present disclosure.

Corresponding reference numerals indicate corresponding parts throughout the several views of the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure.

As used herein, the term “payment card” refers to any suitable cashless payment device, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers. Each type of payment card can be used as a method of payment for performing a transaction.

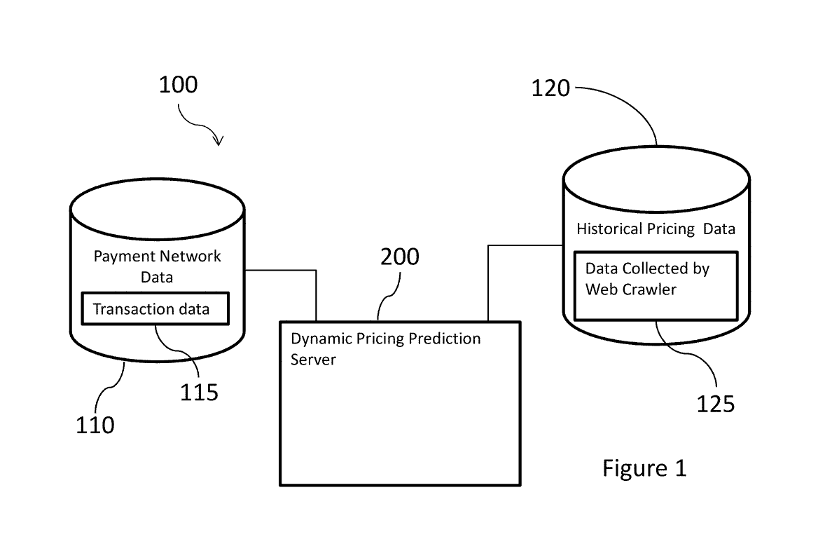

FIG. 1 is a block diagram showing a data processing system according to an embodiment of the present disclosure. The data processing system 100 comprises a dynamic pricing prediction server 200. The dynamic pricing prediction server 200 is coupled to a database which stores payment network data 110, and a database which stores historical pricing data 120.

The payment network data 110, and the historical pricing data may be resident on different servers. The servers may be either within a single data warehouse or distributed over a plurality of data warehouses. The data processed by the dynamic pricing prediction server 200 may be retrieved from the servers, and cleaned and stored in a data warehouse prior to the analyses being conducted. Alternatively, dynamic pricing prediction server 200 may receive the data from servers which may be operated by the different providers.

The payment network data 110 comprises transaction data 115. The transaction data 115 comprises indications of transactions, which indicates information including the time and date of transactions; transaction amount; the card number of a payment card used for the transaction; and the merchant at which the transaction was carried out.

As described in more detail below, the transaction data 115 may comprise data captured by a merchant relating to transactions. For example, when the merchant is an airline, this captured data may include details of a flight booking in addition to details of the transaction.

The historical pricing data 120 comprises data 125 captured by a web crawler. The historical pricing data 120 may be used to assess the performance of price prediction by the dynamic pricing prediction server 200.

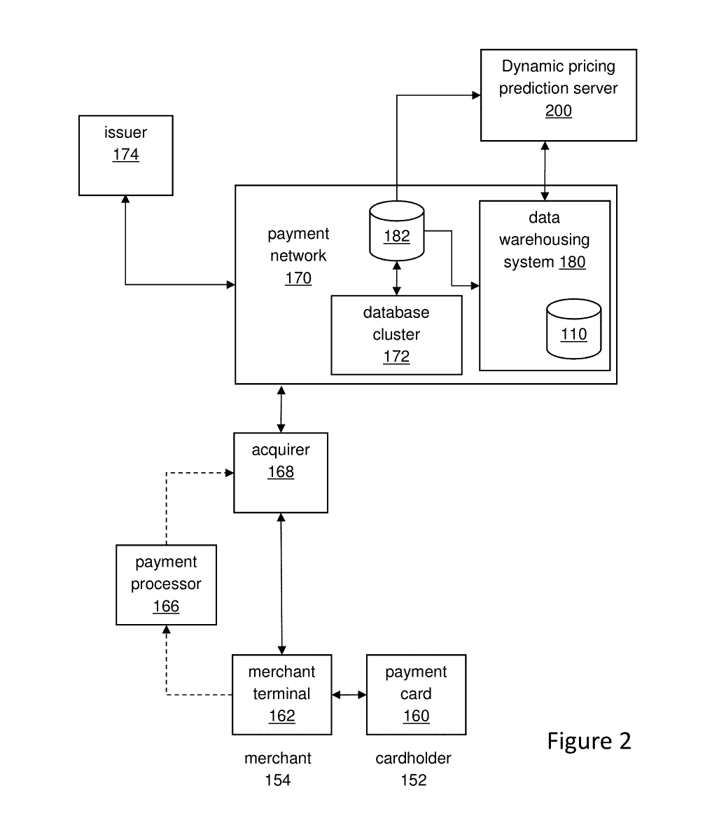

FIG. 2 shows an example of a data processing system which generates the payment network data 110. As shown in FIG. 2, dynamic pricing prediction server 200 receives transaction data from a payment network 170, such as the payment network operated by MasterCard®.

The payment network 170 acts as an intermediary during a transaction being made by a cardholder 152 using a payment card 160 at a merchant terminal 162 of a merchant 154. In particular, the cardholder 152 may present the payment card 160 to merchant terminal 162 of merchant 154 as payment for goods or services. The merchant terminal 162 may be a point of sale (POS) device such as a magnetic strip reader, chip reader or contactless payment terminal, or a website having online e-commerce capabilities, for example. A merchant 154 may operate one or a plurality of merchant terminals 162. The merchant terminal 162 communicates with an acquirer 168 of a bank or other institution with which the merchant 154 has an established account, in order to request authorisation for the amount of the transaction (sometimes referred to as ticket size) from the acquirer 168. In some embodiments, if the merchant 154 does not have an account with the acquirer 168, the merchant terminal 162 can be configured to communicate with a third-party payment processor 166 which is authorised by acquirer 168 to perform transaction processing on its behalf, and which does have an account with the acquirer entity.

The acquirer 168 routes the transaction authorisation request from the merchant terminal 162 to computer systems of the payment network 170. The transaction authorisation request is then routed by payment network 170 to computer systems of the appropriate issuer institution (e.g., issuer 174) based on information contained in the transaction authorisation request. The issuer 174 is authorised by payment network 170 to issue payment card 160 on behalf of the cardholders 152 to perform transactions over the payment network 170. Issuer 174 also provides funding of the transaction to the payment network 170 for transactions that are approved.

The computer systems of the issuer 174 analyse the authorisation request to determine the account number submitted by the payment card 160, and based on the account number, determine whether the account is in good standing and whether the transaction amount is covered by the cardholder's account balance or available credit. Based on this, the transaction can be approved or declined, and an authorisation response message transmitted from issuer 174 to the payment network 170, which then routes the authorisation response message to the acquirer 168. The acquirer 168, in turn, sends the authorisation response message to merchant terminal 162. If the authorisation response message indicates that the transaction is approved, then the account of the merchant 154 (or of the payment processor 166 if appropriate) is credited by the amount of the transaction.

During each authorisation request, as described in the previous paragraphs, the payment network 170 stores transaction information in a transactions database 115 accessible via a database cluster 172. The database cluster 172 may comprise one or more physical servers. In some embodiments, the transactions database 115 may be distributed over multiple devices which are in communication with one another over a communications network, such as a local-area or wide-area network. In some embodiments, the transactions database 115 may be in communication with a data warehousing system 180 comprising a data warehouse database 182 which may store copies of the transaction data, and/or cleaned and/or aggregated data which are transformed versions of the transaction data.

The data warehouse database 182 may also comprise records relating to individual cardholders, which, for example, may associate demographic information, such as age, gender, number of dependents and salary range with a card identifier (e.g., a PAN), thereby permitting transaction data to be matched to demographic data. In some embodiments, each transaction record stored in the data warehouse database 182 may already have the matched demographic data stored as part thereof.

Transaction records (or aggregated data derived therefrom) may be directly accessible for the purposes of performing analyses, for example, by the dynamic pricing prediction server 200, from transactions database 115. Alternatively, or in addition, the transaction records (or aggregated data derived therefrom) may be accessed (for example, by dynamic pricing prediction server 200) from the data warehouse database 182. Accessing the transaction records from the data warehouse database 182, instead of the transactions database 115, has the advantage that the load on the transactions database 115 is reduced.

The transaction records may comprise a plurality of fields, including acquirer identifier/card accepter identifier (the combination of which uniquely defines the merchant); merchant category code (also known as card acceptor business code), that is, an indication of the type of business the merchant is involved in (for example, an airline, travel agent or hotel); cardholder base currency (i.e., U.S. Dollars, Euros, Yen, etc.); the transaction environment or method being used to conduct the transaction; product specific data, such as SKU line item data; the transaction type; card identifier (e.g., card number); time and date; location (full address and/or GPS data); transaction amount (also referred to herein as ticket size); terminal identifier (e.g., merchant terminal identifier or ATM identifier); and response code (also referred to herein as authorization code). Other fields may be present in each transaction record.

The product specific data mentioned above may be Level 3 data. For the purchase of an airline ticket, Level 3 data may comprise indications of the following: a departure time and date for the airline ticket; the card issuing country for the payment card used in the purchase; an origination airport code; an origination country; a destination country; a destination airport code; a merchant category code; a merchant name; a product type; a transaction amount; and a transaction count.

Each terminal identifier may be associated with a merchant 154, for example, in a merchant database of the payment network 170. Typically, a particular merchant 154 will have a plurality of merchant terminal identifiers, corresponding to merchant terminals 162, associated with it.

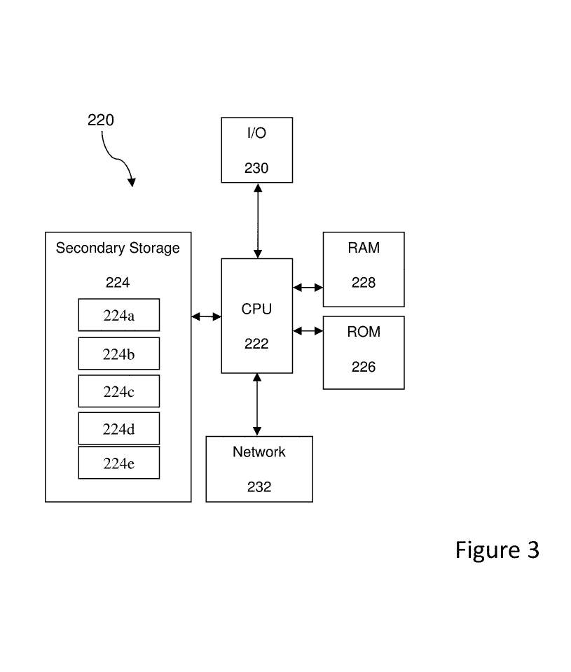

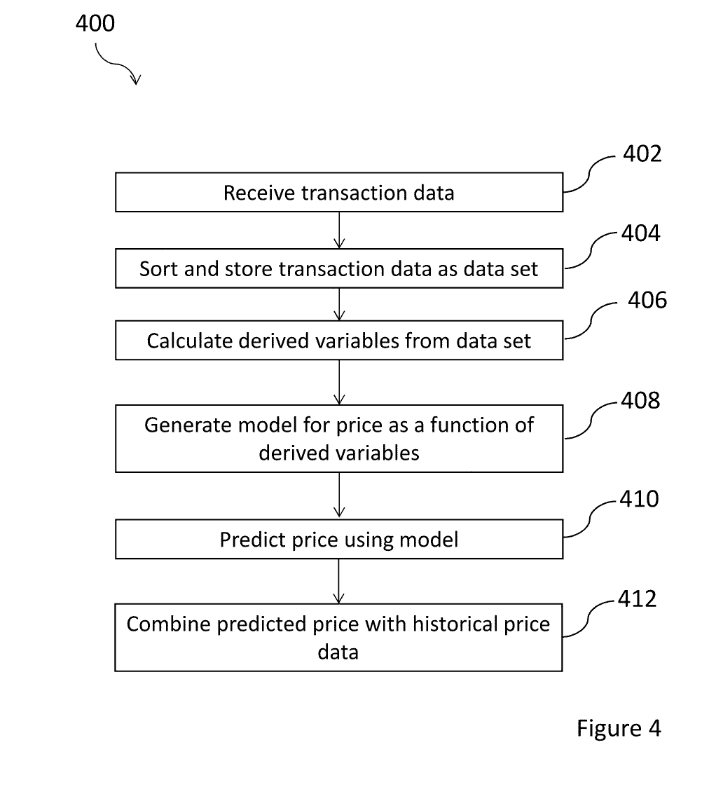

FIG. 3 is a block diagram showing a technical architecture 220 of the server of the dynamic pricing prediction server 200 for performing an exemplary method 400 which is described below with reference to FIG. 4. Typically, the method 400 is implemented by a computer having a data-processing unit. The block diagram as shown in FIG. 3 illustrates a technical architecture 220 of a computer which is suitable for implementing one or more embodiments herein.

The technical architecture 220 includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture 220 may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has a data sorting module 224a, a derived variable calculation module 224b, model generation module 224c, a price prediction module 224d, and a combination module 224e comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols, such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture 220 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture 220, at least one of the CPU 222, the RAM 228, and the ROM 226 are changed, transforming the technical architecture 220, in part, into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Various operations of the exemplary method 400 will now be described with reference to FIG. 4 in respect of analysis of transactions to identify customer segments from transaction data. It should be noted that enumeration of operations is for purposes of clarity and that the operations need not be performed in the order implied by the enumeration.

In step 402, the dynamic pricing prediction server 200 receives transaction data 115 from the database storing the payment network data 110. The transaction data 115 may comprise Level 3 data collected by airlines for transactions carried out by an airline or travel agent acting as a merchant. The Level 3 data comprises information on the purchases of airline tickets such as the airline origin, the airline destination, a flight identifier indicating departure time and date, information on the ticket type and class, such as economy class, premium economy class, or business class.

In step 404, the data sorting module 224a of the dynamic pricing prediction server 200 sorts the transaction data and stores the classification data as a data set. Where the transaction data relates to airline data, a data set may be created for each route for a period, such as the last three years of data. Thus the data set may comprise 3 (years)*365 (days)*24 (hours) rows for each corridor/route.

In step 406, the derived variable calculation module 224b of the dynamic pricing prediction server 200 calculates derived variables from the data set corresponding to a flight route or segment. The derived variables may comprise indications of booking velocity, that is, the percentage of bookings within the last 2 days, the preceding 2 to 5 days, the percentage of bookings made more than 5 days before departure of a flight. The derived variables may also comprise indications of booking amount velocity, that is, the percentage of booking spend within the last 2 days, the preceding 2 to 5 days, and the percentage of total booking spend made more than 5 days before departure. The derived variables may also include the percentage of spend on particular types of payment cards, for example, the percentage of total spend made with Platinum or world elite payment cards.

In step 408, the model generation module 224c of the dynamic pricing prediction server 200 generates a model for the price as a function of the derived variables. The model may be a dynamic statistical model which predicts absolute price and its range on a daily or hourly basis by changing the parameters of the dynamic statistical model.

For example, the dynamic statistical model may be a simple linear regression model. The simple linear regression model models price for a particular route as a set of coefficients each associated with one of the derived variables.

In step 410, the price prediction module 224d of the dynamic pricing prediction server 200 predicts a price using the dynamic statistical model generated in step 408.

In step 412, the combination module 224e of the dynamic pricing prediction server 200 combines the price predicted in step 410 with historic pricing information.

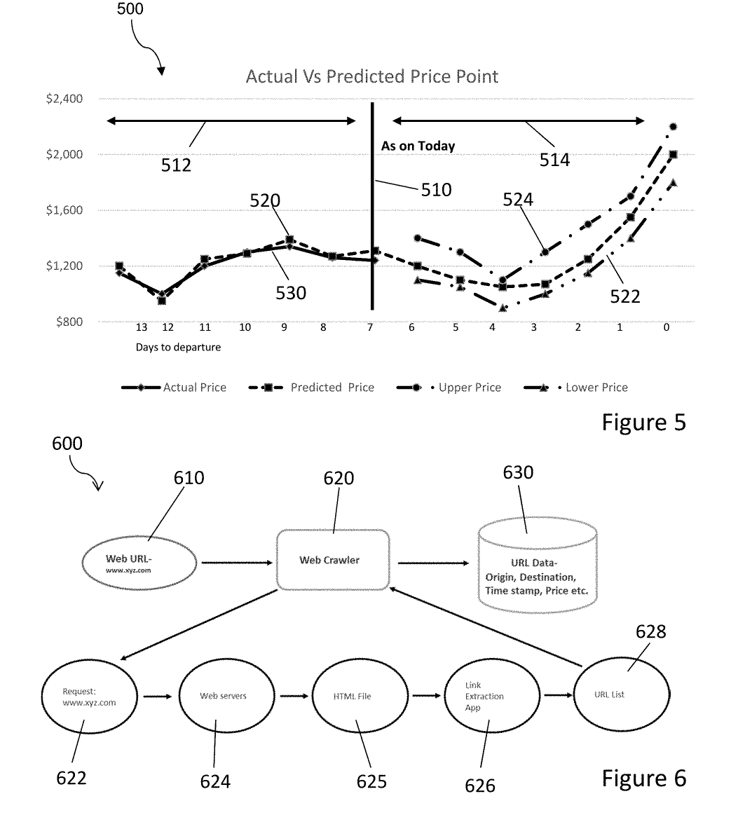

FIG. 5 shows an example of an output graph generated by the method shown in FIG. 4. The output graph 500 shows ticket price against time to departure for a particular route. In the example shown in FIG. 5, the current date 510 is 7 days before departure of the flight for which the price is being predicted. For the time period 512 prior to the current date, a predicted price 520 and an actual price 530 are shown. The predicted price 520 is the dynamic price predicted by the model. The actual price 530 is the price determined from the historical price data. For the time period 514 following the current date, the predicted price 520 and a lower bound 522 for the predicted price and an upper bound 524 for the predicted price are shown. The lower bound 522 and the upper bound 524 are calculated from the model. The lower bound 522 and the upper bound 524 may be calculated from an error estimation applied to the linear regression model. The lower bound 522 and the upper bound 524 may also be calculated from confidence level estimation of the linear regression model.

FIG. 6 shows the process of generating historical price data in an embodiment of the present disclosure. The process 600 takes a web Uniform Resource Locator (URL) 610 as an input. The URL 610 is passed to a web crawler 620. The web crawler 620 sends a request 622 to the web address indicated by the URL 610. This request 622 is sent to web servers 624 which respond with a HTML file 625 for the content being investigated. The web crawler 620 applies a link extraction application 626 to the HTML file 625. The link extraction application 626 returns a URL list 628 which indicates the content of the URL 610. The web crawler 620 extracts URL data 630 from the URL list 628. The URL data 630 may include information, such as pricing information, time stamp information, origin and destination information for flights, and other information, such as class of travel. As described above, the web crawlers 620 visit a number of individual web sites, copy the content of the web sites, match the content in a fixed format and create attributes using the extracted contents. As described above, the extracted data can be used in embodiments for a comparison with the predicted dynamic pricing.

Whilst the foregoing description has described exemplary embodiments, it will be understood by those skilled in the art that many variations of the embodiments can be made within the scope and spirit of the present disclosure.

With that said, and as described, it should be appreciated that one or more aspects of the present disclosure transform a general-purpose computing device into a special-purpose computing device when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer implemented method of predicting dynamic pricing for a product or service, the method comprising:
receiving, at a server, transaction data for a plurality of transactions relating to the product or service, the transaction data comprising transaction information indicating attributes of the transaction and booking information indicating attributes of the product or service;
storing the transaction data on the server as a data set;
calculating, in a derived variable calculation module of the server, derived variables for the data set from the transaction information and/or the booking information;
generating, in a model generation module of the server, a model for the price of the product or service as a function of the derived variables; and
predicting, in a price prediction module of the server, a price for the product or service using the model.

2. The method according to claim 1, wherein the attributes of the transaction comprise a time for the transaction, and wherein one of the derived variables is a percentage of transactions within a time period.

3. The method according to claim 2, wherein the attributes of the product or service comprise a time associated with the product or service and the time period is a time period relative to the time associated with the product or service.

4. The method according to claim 3, wherein the product or service is a travel ticket and the time associated with the product or service is a departure time.

5. The method according to claim 1, further comprising predicting a price for the product or service at a plurality of future times.

6. The method according to claim 1, further comprising determining a price for the product or service at a plurality of past times using the model.

7. The method according to claim 6, further comprising receiving historical price information for the product or service and combining, in a data combination module of the server, the historical price information with the price for the product or service at a plurality of past times.

8. The method according to claim 1, further comprising sorting the transaction data in a data sorting module of the server according to an attribute of the product or service.

9. The method according to claim 8, wherein the product or service is a travel ticket and sorting the transaction data comprises sorting the transaction data according to travel routes.

10. A non-transitory computer readable medium having stored thereon program instructions for predicting dynamic pricing for a product or service, which when executed by at least one processor cause the at least one processor to:
receive transaction data for a plurality of transactions relating to the product or service, the transaction data comprising transaction information indicating attributes of the transaction and booking information indicating attributes of the product or service;
store the transaction data as a data set on a server in communication with the at least one processor;
calculate, in a derived variable calculation module of the server, derived variables for the data set from the transaction information and/or the booking information;
generate, in a model generation module of the server, a model for the price of the product or service as a function of the derived variables; and
predict, in a price prediction module of the server, a price for the product or service using the model.

11. An apparatus for identifying customer segments from transaction data, the apparatus comprising:
a computer processor and a data storage device, the data storage device having a derived variable calculation module; a model generation module; and a price prediction module comprising non-transitory instructions, which when executed by the processor, cause the processor to:
receive transaction data for a plurality of transactions relating to the product or service, the transaction data comprising transaction information indicating attributes of the transaction and booking information indicating attributes of the product or service;
store the transaction data as a data set;
calculate derived variables for the data set from the transaction information and/or the booking information;
generate a model for the price of the product or service as a function of the derived variables; and
predict a price for the product or service using the model.

12. The apparatus according to claim 11, wherein the attributes of the transaction comprise a time for the transaction, and wherein one of the derived variables is a percentage of transactions within a time period.

13. The apparatus according to claim 12, wherein the attributes of the product or service comprise a time associated with the product or service and the time period is a time period relative to the time associated with the product or service.

14. The apparatus according to claim 13, wherein the product or service is a travel ticket and the time associated with the product or service is a departure time.

15. The apparatus according to claim 11, wherein the price prediction module further comprises non-transitory instructions operative by the processor to predict a price for the product or service at a plurality of future times.

16. The apparatus according to claim 11, wherein the price prediction module further comprises non-transitory instructions operative by the processor to determine a price for the product or service at a plurality of past times using the model.

17. The apparatus according to claim 16, wherein the data storage device further comprises a combination module comprising non-transitory instructions, which when executed by the processor, cause the processor to receive historical price information for the product or service and combine the historical price information with the price for the product or service at a plurality of past times.

18. The apparatus according to claim 11, wherein the data storage device further comprises a data sorting module comprising non-transitory instructions, which when executed by the processor, cause the processor to sort the transaction data according to an attribute of the product or service.

19. The apparatus according to claim 18, wherein the product or service is a travel ticket; and wherein the non-transitory instructions, when execute by the processor in connection with sorting the transaction data, further cause the processor to sort the transaction data according to travel routes.
